(19) United States
(12) Patent Application Publication
(10) Pub. No.: US 2018/0190165 A1
(43) Pub. Date: Jul. 5, 2018

(54) Novelty Toilet Sticker

(71) Applicant: The Will Joseph Schreiber Revocable Living Trust, Scottsdale, AZ (US)

(72) Inventor: Will Joseph Schreiber, Scottsdale, PA (US)

(73) Assignee: The Will Joseph Schreiber Revocable Living Trust, Scottsdale, AZ (US)

(21) Appl. No.: 15/398,685

(22) Filed: Jan. 4, 2017

(51) Int. Cl. G09F 19/00; C09J 5/00; C09J 201/00

(52) U.S. Cl. CPC G09F 19/00; C09J 201/00; C09J 5/00

(57) ABSTRACT

A novelty toilet sticker depicting a human face caricature is configured for application to a conventional toilet having a lid and a rim with an opening. The sticker includes an upper portion that is applied to the lid and a separate lower portion that is applied to the rim. A first part of the human face caricature is printed on the upper portion and a second part of the human face caricature is printed on the lower portion. When the upper portion and the lower portion are applied to the toilet, they cooperate to depict the human face caricature with a mouth severed between the upper portion and the lower portion to flank the opening. Thus, the sticker presents a complete depiction of the human face caricature on the toilet.

### FIELD OF THE INVENTION

The present invention relates generally to home decor, and more particularly to stickers used in home decor.

### BACKGROUND OF THE INVENTION

People enjoy adding individuality to their homes, whether it is with paint, furniture, decorative products, or other similar items. Homeowners use different methods of home décor to make their homes more pleasant for themselves and also to create an environment conducive to entertaining guests. Novelty items are a particular category of home décor that are useful for furthering these goals. Novelty items are meant to be amusing and provide something to lighten the mood of the observer. They also make great sources of conversation due to their unusual or quirky nature. People buy novelty decorations for their own homes and, for the same reasons, novelty decorations are also popular gift items. In general, the more surprising or unusual the item is, the better it serves its purpose, and so new novelty products are always needed.

### SUMMARY OF THE INVENTION

A novelty toilet sticker depicting a human face caricature is configured for application to a conventional toilet that includes a lid and a rim with an opening. The sticker is constructed and arranged and then applied on the toilet to startle and entertain the observer and user. The sticker includes an upper portion that is applied to the lid and a separate lower portion that is applied to the rim. A first part of the human face caricature is printed on the upper portion and a second part of the human face caricature is printed on the lower portion. When the upper portion and the lower portion are applied to the toilet, they cooperate to depict the human face caricature with a mouth severed between the upper portion and the lower portion to flank the opening. Thus, the sticker presents a complete depiction of the human face caricature on the toilet.

The above provides the reader with a very brief summary of the detailed description presented below, and it is not intended to limit or define in any way the scope of the invention or key aspects thereof. Rather, this brief summary merely introduces the reader to some aspects of the invention in preparation for the detailed description.

### BRIEF DESCRIPTION OF THE DRAWINGS

Referring to the drawings:

FIG. 1 is a front elevation view of a novelty toilet sticker applied to a toilet;

FIG. 2 is a section view of the novelty toilet sticker of FIG. 1 taken along the line 2-2 in FIG. 1;

FIGS. 3A-3D are perspective views showing a sequence of steps of applying the novelty toilet sticker to a toilet; and

FIG. 4 is a front elevation view of an alternate embodiment of the novelty toilet sticker of FIG. 1.

### DETAILED DESCRIPTION

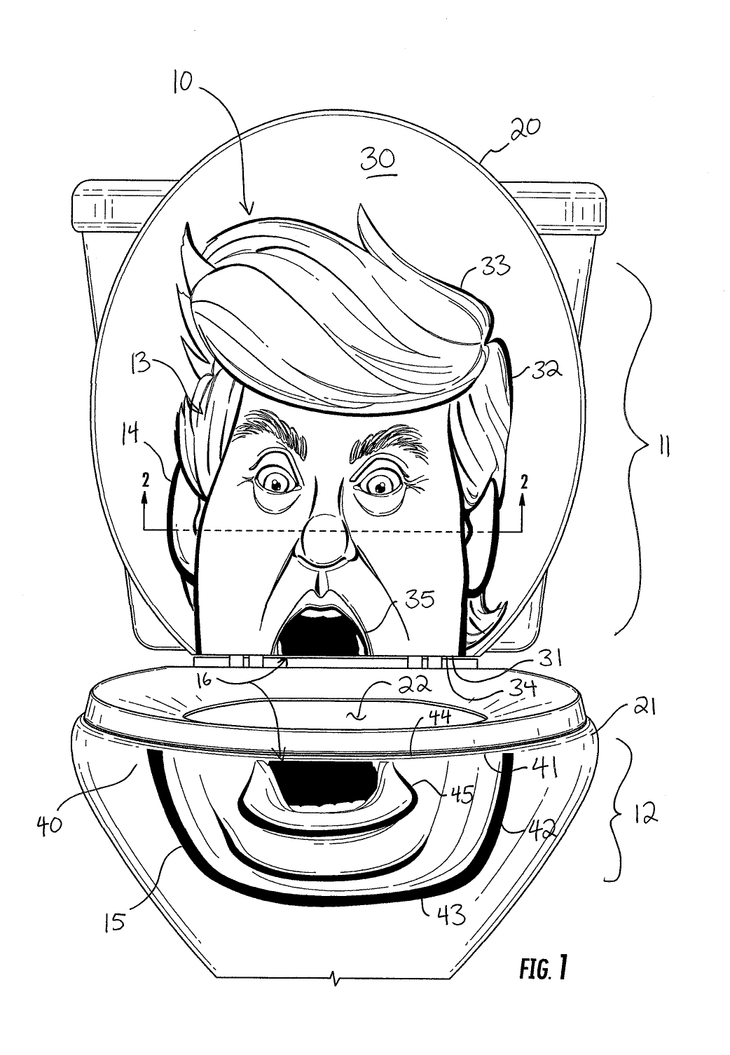

Reference now is made to the drawings, in which the same reference characters are used throughout the different figures to designate the same elements. FIG. 1 shows a novelty toilet sticker 10 (hereinafter, the “sticker 10”) applied to a conventional toilet 9. The toilet 9 is a conventional toilet and includes a lid 20 and a rim 21 surrounding an opening 22 into the bowl of the toilet 9. The sticker 10 includes an upper portion 11 that is applied to the lid 20 and a separate lower portion 12 that is applied to the rim 21. A design of a human face or human face caricature 13 is printed on the sticker 10. A first part 14 of the human face caricature 13 is printed on the upper portion 11, and a second part 15 of the human face caricature 13 is printed on the lower portion 12. When the upper portion 11 and the lower portion 12 are applied to the toilet 9 in an applied condition, they cooperate to depict the human face caricature 13 with a mouth 16 of the human face caricature 13 severed between the upper portion 11 and the lower portion 12 to flank the opening 22. Thus, the sticker 10 presents a humorous depiction of the human face caricature 13 on the toilet 9.

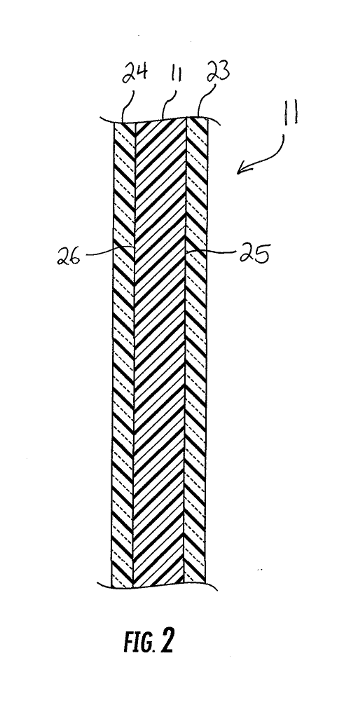

FIG. 2 shows a cross section of the sticker 10 and its three-layer construction before it is applied to a toilet 9. The following description will refer to the upper portion 11 primarily, with the understanding that the lower portion 12 is similarly constructed and thus that the ensuing description applies equally to the lower portion 12, except where otherwise identified. For instance, only the upper portion 11 is shown in FIG. 2 for clarity of the drawing, but both the upper portion 11 and the lower portion 12 have the construction shown in FIG. 2. The upper portion 11 and the lower portion 12 are each constructed of very thin paper, plastic, or other material suitable for printing a permanent design on. The upper portion 11 of the sticker 10 is disposed between a backing layer 23 and a protective cover 24, all of which are coextensive with one another. The human face caricature 13 is printed on a front 25 of the upper portion 11 and the lower portion 12. The protective cover 24 is an applique which covers the front 25 so that the human face caricature 13 is not damaged before or during application of the sticker 10 to the toilet 9. The protective cover 24 is easily peeled from the sticker 10 after the sticker 10 is applied to the toilet. The protective cover 24 is a very thin layer of clear, flexible, transparent material, such as plastic, that allows the human face caricature 13 to be visible through the protective cover 24. Opposed from the front 25, the upper portion 11 has an adhesive back 26 for adhering the sticker 10 to the toilet 9. The adhesive back 26 is covered by the backing layer 23, which is a very thin and flexible layer of waxy paper which can easily be peeled away to expose the adhesive back 26.

Returning to FIG. 1, the sticker 10 is applied to the toilet 9 with the upper portion 11 applied to an underside of the lid 20. The underside 30 of the lid 20 has a generally oval shape and a bottom straight edge 31 proximate to the opening 22. The upper portion 11 is sized to cover the majority of the underside 30 of the lid 20, making it readily visible when the lid 20 is open, and is located against the straight edge 31. The upper portion 11 is bound by an upper peripheral edge 32 that extends around the entire perimeter of the upper portion 11. The upper peripheral edge 32 includes an upper profile edge 33 and a straight bottom edge 34. The upper profile edge 33 depicts an outline of the human face caricature at the upper portion 11 and thus has an irregular shape forming cheeks, ears, hair, and like facial elements. The bottom edge 34 is registered with the edge 31 of the lid 20. The registration of the edge 34 of the upper portion 11 with and against the edge 31 of the lid 20 locates the upper portion 11 as close as possible vertically to the lower portion 12 in its position on the rim 21, thereby making clear that the upper portion 11 and the lower portion 12 depict two parts of the same human face caricature 13. The upper portion 11 depicts the first part 14 of the human face caricature 13 and includes a first portion 35 of the mouth 16 abutting the bottom edge 34. The first part 14 generally includes hair, eyes, a nose, cheeks, ears, and the upper, or first portion 35, of the mouth 16.

The lower portion 12 is applied to a front 40 of the rim 21 across the opening 22 from the lid 20. At the opening 22 of the rim 21, the lower portion 12 and the upper portion 11 have widths that are equal in size, which makes the human face caricature 13 readily recognizable. The lower portion 12 is bounded by a lower peripheral edge 42 that extends around the entire perimeter of the lower portion 12. The lower peripheral edge 42 includes a lower profile edge 43 and a top edge 44. The top edge 44 is aligned with an edge 41 of the rim 21 that is proximate to the opening 22, such that the top edge 44 opposes the bottom edge 34 of the upper portion 11. The top edge 44 is slightly curved to follow closely and correspond to the curvature of the rim 21. The registration of the edge 44 against the edge 41 of the rim 21 locates the lower portion 12 as close as possible vertically to the upper portion 11 in its position on the lid 20, thereby making clear that the upper portion 11 and the lower portion 12 depict two parts of the same human face caricature 13. The lower profile edge 43 depicts an outline of the human face caricature 13 at the lower portion 12. The lower profile edge 43 of the lower portion 12 and the upper profile edge 33 of the upper portion 11 are aligned such that they cooperate to depict a complete human face profile which bounds the human face caricature 13. That human face profile is the union of the upper and lower portions 11 and 12, and outlines the entire human face caricature 13. The lower portion 12 contains the second part 15 of the human face caricature 13 with a second portion 45 of the mouth 16 abutting the top edge 44. The second part 15 generally includes a chin and the second portion 45 of the mouth 16.

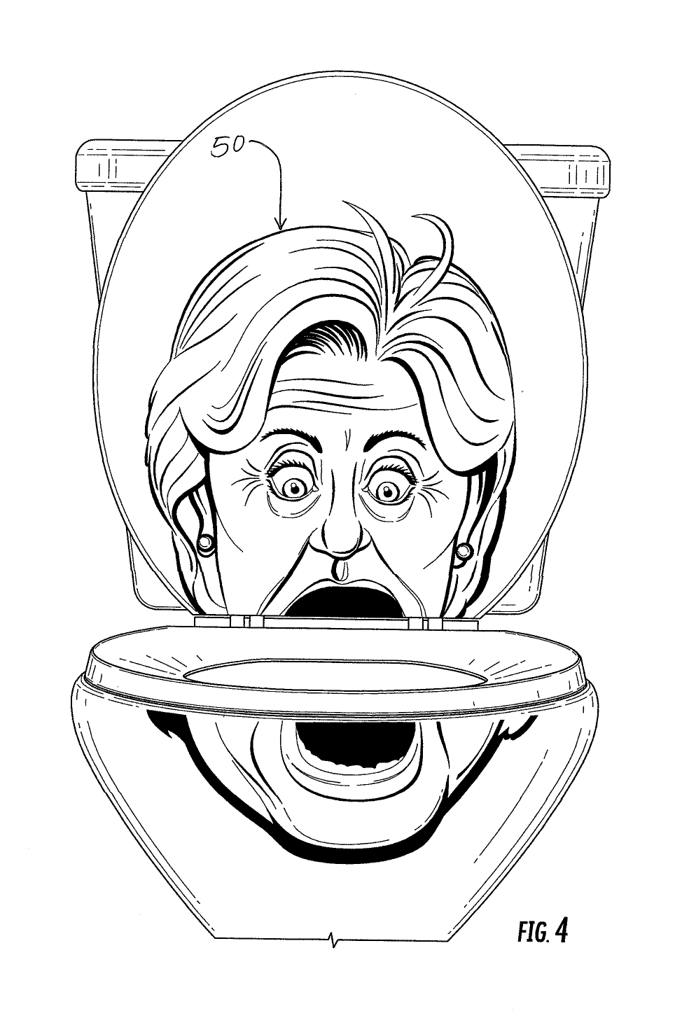

When the upper portion 11 is applied to the lid and the lower portion 12 is applied to the rim 21 as described above, the first part 14 and the second part 15 of the human face caricature 13 are registered with one another to form in the sticker 10 a complete depiction of the human face caricature 13. Likewise, the first portion 35 and the second portion 45 of the mouth 16 are registered with each other across the opening 22 of the rim 21 such that the mouth 16 flanks the opening 22 in a vertical orientation. Thus, the sticker 10 presents a humorous depiction of the human face caricature 13 on the toilet 9. The human face caricature 13 can be based on different people as illustrated by the alternate embodiment of a novelty toilet sticker 50 in FIG. 4, and indeed, may be based on many other faces and types of faces, such as that of an animal, a cartoon character, an inanimate object such as clock or car, or the like.

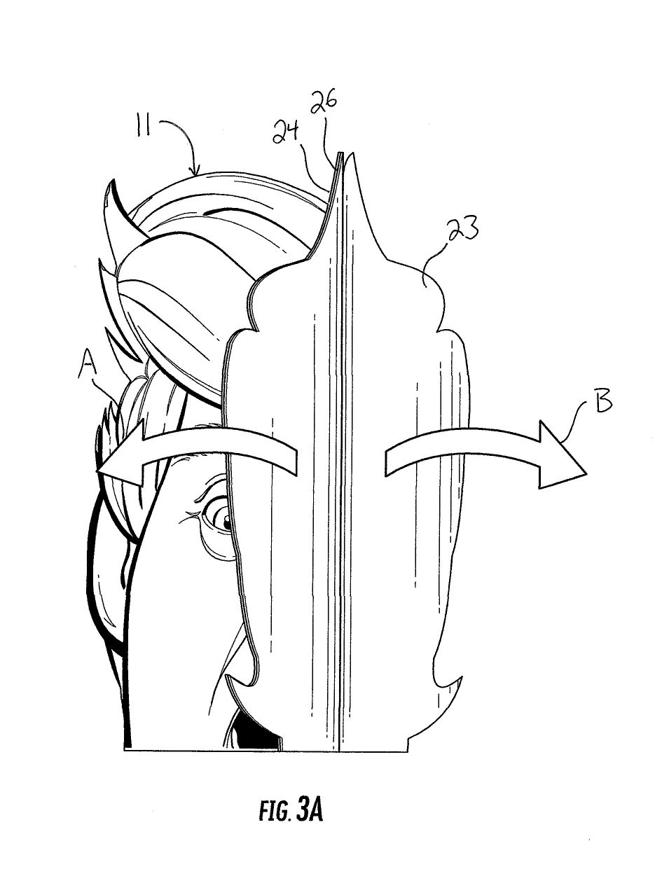

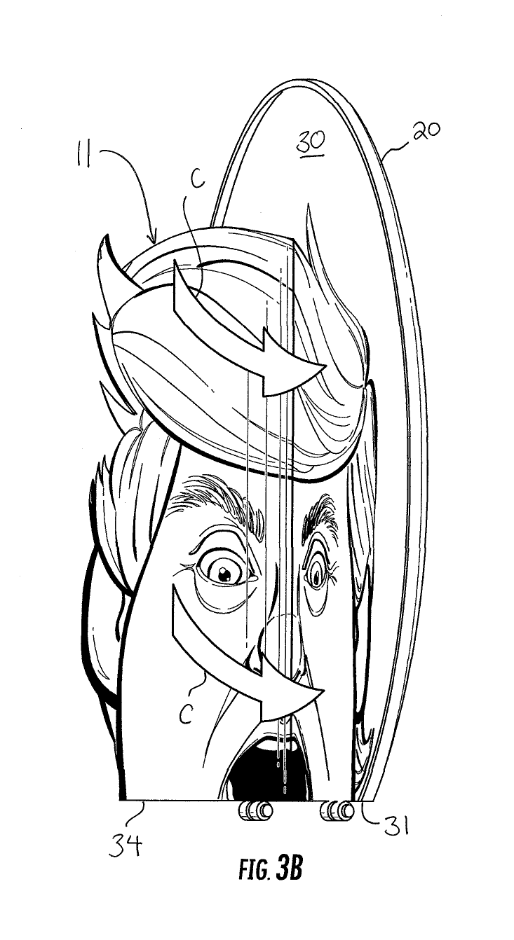

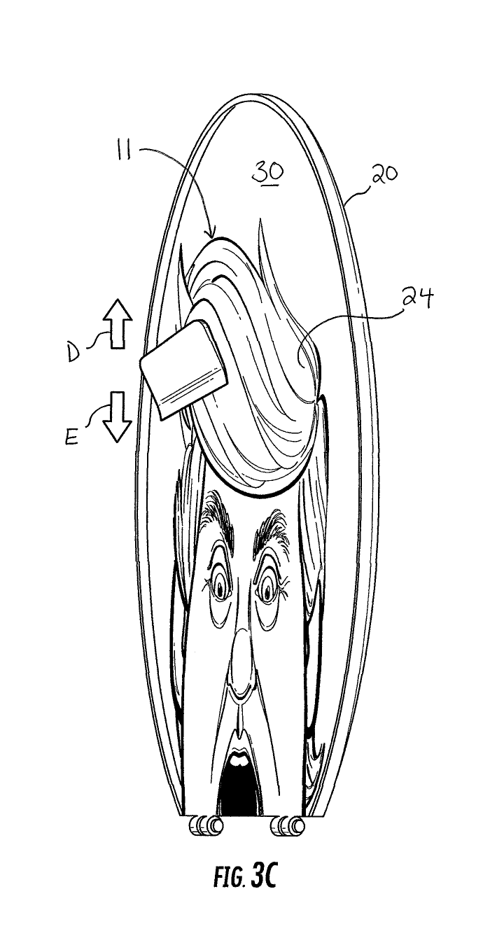

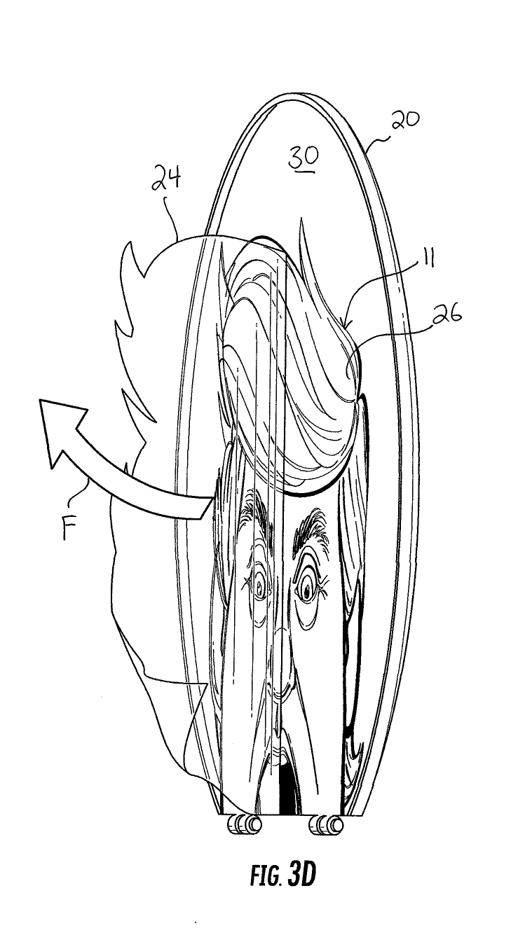

As stated above, the sticker 10 is useful for depicting a human face caricature 13 when applied to a toilet 9 in an application condition. Application of the sticker 10 to a toilet will now be discussed with reference to FIGS. 3A-3D which illustrate a sequence of steps of removing the backing layer 23, applying the sticker 10 to the toilet 9, smoothing the sticker with a flat object, and removing the protective cover 24. A person performs all of these steps, preferably by hand. FIGS. 3A-3D show the steps of applying the upper portion 11 only to the toilet 9 into an applied condition; one having ordinary skill in the art will readily appreciate that the lower portion 12 is applied in a similar manner, and as such, the description applies equally to the lower portion 12, except as specifically noted.

The first step in applying the sticker 10 to a toilet 9 is to peel off the backing layer 23. FIG. 3A shows the backing layer 23 peeled partially away from the upper portion 11 of the sticker 10. The arrows A and B indicate the directions in which the upper portion 11 and the backing layer 23 are pulled to separate them from each other. Removing the backing layer 23 exposes the adhesive back 26 so that the upper portion 11 may be adhered to the lid 20 of the toilet 9. FIG. 3B shows the upper portion 11 being applied to the lid 20 in a lateral manner, or from one side to the other. After removing the backing layer 23, the person installing the sticker 10 aligns the bottom edge 34 of the upper portion 11 with the edge 31 of the lid 20 and presses the upper portion 11 onto the lid 20 along lines C so that the adhesive back 26 sticks to the lid 20. Alternatively, only some of the backing layer 23 may be peeled away such that there is an exposed section of the adhesive back and a covered section of the adhesive back 26, and the exposed section is applied to the lid 20 before peeling the backing layer 23 from the covered section of the adhesive back 26.

Turning now to FIG. 3C, once applied on the lid 20, the upper portion 11 is smoothed using a flat edge such as a wallpaper smoothing tool or other similar tool. The person presses the flat edge against the upper portion 11 and moves it across the upper portion 11 such as in the directions indicated by the arrows D and E in FIG. 3C. This action forces any bubbles from between the upper portion 11 and the lid 20 and ensures that the entire upper portion 11 is adhered to the lid 20. The protective cover 24 protects the upper portion 11 during the smoothing step and is then removed when the step is completed. The protective cover 24 is peeled away from the upper portion 11 along line F in the same manner as the backing layer 23, as illustrated in FIG. 3D. Once the protective cover 24 is removed, application of the upper portion 11 to the lid 20 is complete. Application of the lower portion 12 to the rim 21 is accomplished through similar steps of removing the backing layer 23, applying the sticker 10 to the toilet, smoothing the sticker 10 with a flat object, and removing the protective cover 24. However, the lower portion 12 of the sticker 10 is applied to the rim 21 by aligning and registering the top edge 44 of the lower portion 12 along the edge 41 of the rim 21. When both the upper and lower portions 11 and 12 are in the applied condition, the first and second portions 35 and 45 of the mouth 16 flank the opening 22 of the rim 21 of the toilet 9, and the upper and lower portions 11 and 12 depict the entirety of the human face caricature.

A preferred embodiment is fully and clearly described above so as to enable one having skill in the art to understand, make, and use the same. Those skilled in the art will recognize that modifications may be made to the described embodiment without departing from the spirit of the invention. To the extent that such modifications do not depart from the spirit of the invention, they are intended to be included within the scope thereof.

The invention claimed is:

1. A sticker for application to a toilet, the toilet including a rim bounding an opening, the sticker comprising:
an upper portion comprising a first part of a human face caricature;
a lower portion comprising a second part of the human face caricature;
a mouth of the human face caricature, the mouth being severed between the upper and lower portions; and
the upper and lower portions are applicable to the toilet in an applied condition, the applied condition characterized by the mouth flanking the opening and the upper and lower portions cooperating to depict the human face caricature.

2. The sticker of claim 1, wherein the upper portion and the lower portion are separate.

3. The sticker of claim 1, wherein the toilet further includes a lid with an underside, and in the applied condition, the upper portion is applied to the underside of the lid.

4. The sticker of claim 3, wherein in the applied condition, the upper portion of the sticker covers a majority of the underside of the lid.

5. The sticker of claim 1, wherein the lower portion and the upper portion have widths that are equal at the opening of the rim.

6. The sticker of claim 1, wherein in the applied condition, the lower portion is applied to the rim.

7. The sticker of claim 1, further comprising:
an upper peripheral edge bounding the upper portion and including an upper profile edge and a bottom edge;
a lower peripheral edge bounding the lower portion and including a lower profile edge and a top edge; and
in the applied condition, the bottom and top edges oppose each other, and the upper and lower profile edges cooperate to depict a human face profile, said human face profile bounding the human face caricature.

8. The sticker of claim 6, wherein the mouth of the human face caricature is severed to locate the mouth at the bottom edge of the upper portion and top edge of the lower portion.

9. A sticker for adhering to a toilet, the toilet including a rim with both an opening and a front, and a lid with an underside, the sticker comprising:
an upper portion comprising:
a first face-shaped part of a human face;
a bottom edge;
a first portion of a mouth abutting the bottom edge; and
the upper portion is configured to adhere to the underside of the lid with the bottom edge proximate to the opening;
a lower portion comprising:
a second face-shaped part of the human face;
a top edge;
a second portion of the mouth abutting the top edge; and
the lower portion is configured to adhere to the front of the rim with the top edge proximate to the opening;
wherein when the upper portion is adhered to the underside of the lid and the lower portion is adhered to the rim, the upper portion cooperates with the lower portion to form in the sticker a complete depiction of the human face with the first and second portions of the mouth registered across the opening of the rim.

10. The sticker of claim 9, wherein the upper portion and the lower portion are separate.

11. The sticker of claim 9, wherein the upper portion of the sticker covers a majority of the underside of the lid when applied to the lid.

12. The sticker of claim 9, wherein the lower portion and the upper portion have widths that are equal at the opening of the rim.

13. The sticker of claim 9, wherein the bottom edge of the upper portion is straight and the top edge of the lower portion has a curvature corresponding to the rim of the toilet.

14. The sticker of claim 9 wherein:
the toilet further includes a first edge at the front of the rim, and a second edge at the underside of the lid;
the top edge of the lower portion is shaped to align with the first edge at the front of the rim; and
the bottom edge of the upper portion is shaped to align with the second edge at the underside of the lid.

15. A method of applying a sticker to a toilet including a rim and a lid with an underside, the method comprising the steps of:
providing a sticker including an upper portion and a lower portion each having an adhesive back, a backing layer covering the adhesive back, and a protective cover opposed from the backing layer;
removing the backing layer of the upper portion;
applying the adhesive back of the upper portion to the lid;
removing the backing layer of the lower portion;
applying the adhesive back of the lower portion to the rim;
smoothing the upper and lower portions with a flat edge; and
removing the protective cover of each of the upper and lower portions.

16. The method of claim 15, wherein the step of applying the adhesive back of the upper portion to the lid further includes applying the adhesive back of the upper portion to the underside of the lid.

17. The method of claim 15, wherein:
the toilet includes an edge on the rim and an edge on the underside of the lid;
the upper portion includes a bottom edge and the lower portion includes a top edge;
the step of applying the adhesive back of the upper portion to the lid includes aligning the bottom edge of the upper portion with the edge on the underside of the lid; and
the step of applying the adhesive back of the lower portion to the rim includes aligning the top edge of the lower portion with the edge of the rim.

18. The method of claim 15, wherein:
the step of removing the backing layer of the upper portion further comprises removing only a part of the backing layer such that there is an exposed section of the adhesive back and a covered section of the adhesive back;
the step of applying the adhesive back of the upper portion to the lid further comprises applying the exposed section of the adhesive back to the lid, and peeling the backing layer from the covered section of the adhesive back;
the step of removing the backing layer of the lower portion further comprises removing only a part of the backing layer such that there is an exposed section of the adhesive back and a covered section of the adhesive back; and
the step of applying the adhesive back of the lower portion to the rim further comprises applying the exposed section of the adhesive back to the rim and peeling the backing layer from the covered section of the adhesive back.
